(19) United States
(12) Patent Application Publication
(10) Pub. No.: US 2012/0315611 A1
(43) Pub. Date: Dec. 13, 2012

(54) SYSTEM AND METHOD FOR SPORTS OFFICIALS TRAINING

(76) Inventor: Robert Arnone, Brownsboro, AL (US)

(21) Appl. No.: 13/158,704

(22) Filed: Jun. 13, 2011

(51) Int. Cl. G09B 19/00

(52) U.S. Cl. 434/219

(57) ABSTRACT

The present invention is a system to train sports officials that includes a server system with a processor system, a communications interface, a communications system, an input system, an output system and a input and output system having access to a communications network and a memory system with an operating system, a communications module, a web browser module, a web server application and a sports official training application to train sports officials. The system also includes a method for training sports officials that includes a client system establishing communication with a server system provided with a sports official training application, the client system receiving information from the sports official training application, the client system receiving the sports official training application and the client system utilizing the sports official training application to train sports officials.

### TECHNICAL FIELD & BACKGROUND

Sports officials are generally required to resolve stressful conflicts and make immediate decisions under pressure, which is why high quality training is essential to the position. The current state of sports officials training is based predominantly on book study, classroom and Power Point instruction, video review, and on-field experience coupled with evaluations, all of which have limitations and cannot provide officials with a realistic and all-inclusive learning experience.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a system overview of a system for sports official training, in accordance with one embodiment of the present invention.

FIG. 2A illustrates a block diagram of a client system of a system for sports official training, in accordance with one embodiment of the present invention.

FIG. 2B illustrates a block diagram of a server system of a system for sports official training, in accordance with one embodiment of the present invention.

FIG. 3 illustrates a flow chart of a method for sports official training, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase in one embodiment is utilized repeatedly. The phrase generally does not refer to the same embodiment, however, it may. The terms comprising, having and including are synonymous, unless the context dictates otherwise.

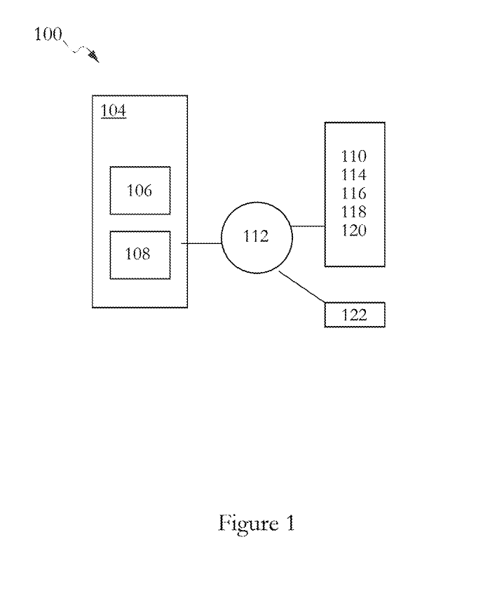

FIG. 1A illustrates a system overview of a system 100 for sports official training, in accordance with one embodiment of the present invention. The computerized system 100 includes a server system 104, an input system 106, an output system 108, a plurality of client systems 110, 114, 116, 118 and 120, a communications network 112 and a hand-held device 122. In other embodiments, the computerized system 100 may include additional components and/or may not include all of the components listed above.

The server system 104 may have one or more servers. One server 104 may be the property of the distributor of the software and then each individual establishment may have their own server also. In other embodiments, the computerized system 100 may include additional components and/or may not include all of the components listed above.

There is also an input system 106 system that may include any one of, some of, any combination of, or all of a keyboard system, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

There is also an output system 108 which may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

The computerized system 100 illustrates some of the variations of the manners of connecting to the server system 104. Server system 104 may be directly connected and/or wirelessly connected to the plurality of client systems 110, 114, 116, 118 and 120 and are connected via the communications network 112. The communications network 112 may be any one of, or any combination of, one or more Local Area Networks (LANs), Wide Area Networks (WANs), wireless networks, telephone networks, the Internet and/or other networks. The communications network 112 may include one or more wireless portals. The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112. The client system 122 is an example of a handheld wireless device, such as a mobile phone or a handheld network enabled audio/music player, which may also be used for accessing network content.

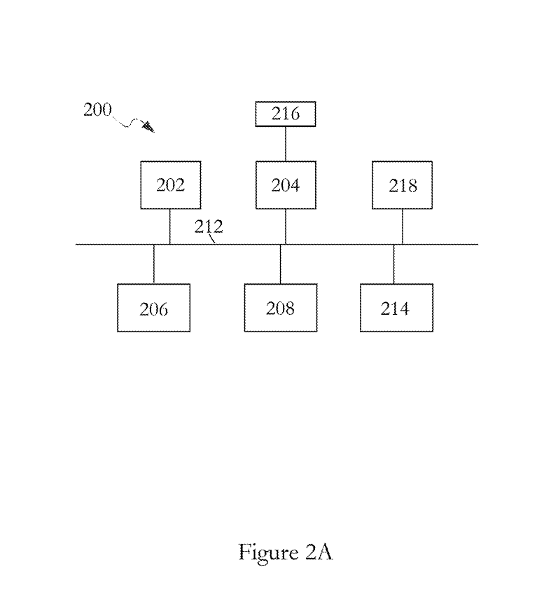

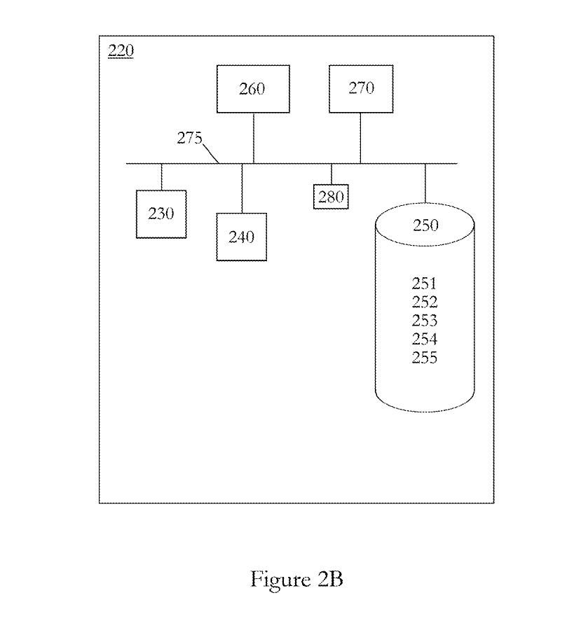

FIG. 2A illustrates a block diagram of a client system 200 of a system for sports official training, in accordance with one embodiment of the present invention. Client system 200 may include an output system 202, an input system 204, a memory system 206, a processor system 208, a communications system 212 and an input/output system 214. Other embodiments of client system 200 may not have all of the components and/or may have other embodiments in addition to or instead of the components listed above. The client system 200 may be any one of client systems 110, 114, 116, 118, 120, and/or 122 that may be used as one of the network devices of FIG. 1. In other embodiments, the client system 200 may include additional components and/or may not include all of the components listed above.

Output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, intranet, and/or the Internet, for example.

Input system 204 may include any one of, some of, any combination of, or all of a keyboard system, a mouse system, a joystick, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB), for example.

Memory system 206 may include, for example, any one of, some of, any combination of or all of a long term storage system, such as a hard drive, a short term storage system, such as random access memory; a removable storage system, such as a floppy drive, a CDROM or a removable drive, and/or a flash memory. Memory system 206 may include one or more machine readable mediums that may store a variety of different types of information. The term machine-readable medium is used to refer to any medium that is structurally configured for carrying information in a format that is readable by a machine. One example of a machine-readable medium is a computer-readable medium. Memory system 206 may store an application for receiving, storing, retrieving, and displaying usage information of various establishments, if system 200 is a server for one of the establishments. Memory system 206 may also store machine instructions for training sports officials if the system 200 is a server.

The processor system 208 may include any one of, some of, any combination of, or all of multiple parallel processors, a single processor, a system of processors having one or more central processors and/or one or more specialized processors dedicated to specific tasks. Processor system 208 implements the programs stored in the memory system 206.

Communications system 212 communicatively links output system 202, input system 204, memory system 206, processor system 208, and/or input/output system 214 to each other. Communications system 212 may include any one of, some of, any combination of, or all of electrical cables, fiber optic cables, and/or means of sending signals through air or water (e.g. wireless communications), or the like. Some examples of sending signals through air and/or water include systems for transmitting electromagnetic waves such as infrared and/or radio waves and/or systems for sending sound waves.

Input/output system 214 may include devices that have the dual function as input and output devices. For example, input/output system 214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example.

The client systems 110, 114, 116, 118, 120 and handheld wireless device 122 can also be tied into a website or wireless portal 218 which is also tied directly into the communications system 212. Any website or wireless portal 218 would also include software and a website module (no number) to maintain, allow access to and run the website as well.

FIG. 2B illustrates a block diagram of a server system 220 of a system for sports official training, in accordance with one embodiment of the present invention. The server system 220 may include an output system 230, an input system 240, a memory system 250, a processor system 260, a communications interface 270, a communications system 275 and an input/output system 280. There may also be an operating system 251, a communications module 252, a web browser module 253, a web server application 254 and a sports official training application 255. In other embodiments, the server system 220 may include additional components and/or may not include all of the components listed above.

Output system 230 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

Input system 240 may include any one of, some of, any combination of, or all of a keyboard system, a joystick 216, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example.

Memory system 250 may include, for example, any one of, some of, any combination of, or all of a long term storage system, such as a hard drive; a short term storage system, such as random access memory; a removable storage system, such as a floppy drive, a CDROM disc or a removable drive and/or flash memory. Memory system 250 may include one or more machine-readable mediums that may store a variety of different types of information. The term machine-readable medium is used to refer to any medium capable carrying information that is readable by a machine. One example of a machine-readable medium is a computer-readable medium. Memory system 250 may store one or more machine instructions for producing web pages for and collecting information for training sports officials. The operating system 251 is provided on the memory system 250. The communications module 252 enables the server system 220 to communicate on the communications network 112 and is stored on the memory system 250. The web browser module 253 allows for browsing the Internet that is stored on the memory system 250. The web server application 254 is software provided to allow for browsing on the Internet. The sports official training application 255 is software provided to store sports related training information that is used by the server system 220.

Processor system 260 may include any one of, some of, any combination of, or all of multiple parallel processors, a single processor, a system of processors having one or more central processors and/or one or more specialized processors dedicated to specific tasks. Processor system 260 may include one or more digital signal processors (DSPs) in addition to or in place of one or more central processing units (CPUs) and/or may have one or more digital signal processing programs that run on one or more CPU. Processor system 260 may implement the machine instructions stored in memory system 250.

The communication interface 270 allows the server system 220 to interface with the network 112. Communications system 275 communicatively links output system 230, input system 240, memory system 250, processor system 260 and/or input/output system 280 to each other. Communications system 275 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

Input/output system 280 may include devices that have the dual function as input and output devices. For example, input/output system 280 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 280 is optional and may be used in addition to or in place of output system 230 and/or input device 240.

The system and method for sports officials training develops a suite of training and evaluation simulations geared towards the training and continued development and evaluation of sports officials. These simulations can also be adapted for use by individual players and coaches to learn proper techniques, and by teams to prepare for opponents. Although the system and method for sports officials training can be utilized at any level, high school football will be used as an example.

For an individual official, definitions, fundamentals, case play, positioning (of officials that include 5, 6, and 7-man crews), special situations (by official position), game plays and evaluation options can be selected from a home screen. For crews and associations, positioning, case plays, scenario development, game plays, evaluations and pre-game options can be selected from a home screen.

While the individual and crew applications are anticipated to be employed on personal computers, laptops, game boxes, and phone applications, the technology is readily adaptable to a “3D immersion” such that projectors are suited to present a synthetic 3D environment where officials can interact and respond to game situations. This application would be more expensive and require an infrastructure most individuals would likely not be able to afford. However, the system and method for sports officials training would be an appropriate tool that can be effectively utilized at the district and state level training camps.

This 3D immersion could also be utilized for recruiting new officials and possibly for entertainment/educational displays at events such as the “NFL Experience” leading to the Super Bowl. This may also be utilized at higher levels of football (most likely NCAA and above) to purchase for the purpose of preparing for opponents where the team QB can be “immersed” in a 3D environment to get his view of defensive formations and shifts. The same could apply to defensive captains preparing for opponent offenses. Rather than depending on scout teams and repetitions, the computer animation may add reps to augment on-field practices.

Using the National Federation of High School (NFHS) football rule book, the official would click onto the “Definitions” tab. The official could then see the exact words from the NFHS rule book, an “x's and o's” type depiction of the rule, a 2-D picture of the rule and a 3-D animation of the rule as viewed by the respective official positions on the field (Referee, Umpire, Linesman, Line Judge, Back Judge, and Side and Field Judges as appropriate).

An understanding of the definitions and the fundamentals contribute to the foundation of a person's basic understanding and application of officiating. An official can select “Fundamentals” and subsequently select the exact wording, a 3-D animation of the rule as viewed by position, a birds-eye view and case plays. The NFHS publishes a case book to complement the rule book.

The official can select “Case Plays” and subsequently select specific rules (study mode), the narrative describing the situation, an “x's and o's” type depiction of the rule, a 2-D picture of the rule, a 3-D animation of the rule as viewed by the respective official positions on the field (Referee, Umpire, Linesman, Line Judge, Back Judge, and Side and Field Judges) as appropriate, a bird's eye view, a ruling (from the NFHS case book), a specific rule (test mode), a narrative describing the situation, an “x's and o's” type depiction of the rule, a 2-D picture of the rule, a 3-D animation of the rule as viewed by the respective official positions on the field (Referee, Umpire, Linesman, Line Judge, Back Judge, and Side and Field Judges as appropriate) and a bird's eye view. Based on the scenario presented, the official can decide penalty enforcement, ball location (including down and distance), signals and clock status.

In addition to understanding the rules of the game, an official must be in the proper position and observe the appropriate keys to ensure the play is appropriately covered. When the official selects “Positioning”, the subsequent choices include crew size (e.g., 5, 6 or 7 man crew), position (R, U, L, LJ, BJ, SJ or FJ), game situations (e.g., running play, pass play, scrimmage kick, free kick, etc.) with the exact wording of the respective officials' positioning, keys and responsibilities as well as a bird's eye view of the officials' positioning and field of view (e.g., a cone depicting where the official should be looking) for pre-snap, during the play and the dead ball period after the play is completed.

Based on positioning requirements and responsibilities, each official may be exposed to some situations only he would witness and is best if he sees these situations in advance of a real game. The intent is to ensure a proper ruling is made, that an inadvertent whistle is avoided, and the game is not adversely affected. For example, during a scrimmage kick (punt), one responsibility of a BJ (5 man crew) is to observe the deepest receiver. If the receiver signals for a fair catch, the BJ must ensure the receiver is completely in possession of the ball before the BJ blows the whistle. For this simulation, the official would be presented scenes where the receiver has the ball drop through his hands or deflect off the player. The official would select the crew size (e.g., 5, 6 or 7 man crew), the position (R, U, L, LJ, BJ, SJ or FJ) and game situations (e.g., running play, pass play, scrimmage kick, free kick, etc.).

A game play feature is provided and intended to combine what the official has learned with respect to rules knowledge, fundamentals, and position responsibilities. The official would again select the crew size, position, and game situations. Now, however, the official will have certain game controls to include official repositioning, possibly a joystick type application such that the official can adjust his pre-snap position (e.g., the BJ might move laterally when an offensive back goes into motion or the strength of formation changes during a shift). The official would also use the joystick to change his location as the play evolves. A playback feature, including a birds-eye view would be available to assess performance. Where the above options allow an official to select specific game situations, the evaluation feature presents situations from the case plays in random order. The official will observe these situations in 3D from his selected position (and crew size).

At the crew and association level, the positioning, case plays, game play, and evaluation tabs are similar to the individual level. The intent of the crew level is to combine the individual views into what an entire crew would experience. Each crew member would have his individual laptop to establish where he is positioned and where he is looking. The result of each individual activity is then consolidated into a single view to depict how well the play was covered.

The case plays represent scenarios that facilitate the understanding and application of the rules. The intent of the scenario development feature is to enable the associations and crew chiefs with the ability to reconstruct plays that are not captured in the case book but have been observed during game situations. The resulting 3-D representation will allow officials to be better prepared for specific schools that incorporate special formations and plays in their repertoire.

One characteristic of outstanding crews is that they conduct thorough and comprehensive pre-game discussions and review of responsibilities. If available, the pre-games may include “white board” discussions and depiction of various scenarios. This feature allows the crew chief to select case plays and/or develop scenarios for use in the pre-game preparations.

One of the goals at the District and State levels of training officials is to ensure consistency as the officials interpret rules and enforce penalties. Some camps include live scrimmages by local high school teams. Given these camps are conducted well before the season starts, the level of play and skills do not reflect what the officials will experience “on Friday night”. In addition, some situations (e.g., chop blocks) are situations an official should recognize, but would obviously be something unsafe for student athletes to demonstrate. The use of 3D animation is intended to demonstrate these types of occurrences to include perspectives from crew positions. Despite the best attempts at the District and State levels, various associations, crews and individuals may develop bad habits during the course of the season or generally over time. In Alabama, individual officials from across the State are selected to serve on crews working championship games. In many cases, this is the first time these officials meet. The intent of the mobile training application is to provide a 3D environment within which the crew can interact in preparation for the game.

Initial release of the system and method for sports officials training would include a representation of football situations as viewed by individual members of an officiating crew. The software would include definitions, fundamentals, and case plays. At the individual and crew level, it can also be used for pre-game preparations. Other potential applications may include use by coaches to augment their game preparations and to show proper techniques.

“Story-boarding” may be recommended to assist with the communication of game situations from an official's perspective to the software developer. For example, the official may describe what his responsibilities are during a punt play. Rather than the software developer having to guess the relative position of players, a flat surface depicting a football field (to scale) would be used on which to position the players on the field. These “chess pieces” would be coded with a player jersey number. Once positioned onto the field, the computer would convert the coded pieces to an on-screen, 3D representation of the formation and subsequent play.

The system and method for sports officials training utilizes modern animation and imaging technologies to create simulations and training scenarios for a sports official, thereby providing a comprehensive training guide. Compatible with laptops, desktop computers, most game box makes and models, and even a cellular phone application, the system and method for sports officials training is a software program that is equipped with various training categories such as definitions, fundamentals, case plays, positioning of officials, special situations, game plays, and evaluation. For example, the system and method for sports officials training will delineate rule books for each respective sport, further explore definitions, depict and narrate case plays, explain positioning responsibilities, discuss special situations, and include a joystick application for game play that can reposition the official as needed. Additionally, a playback feature from a bird's-eye view will allow an official to assess the performance. The system and method for sports officials training will be available with an extensive instruction manual for optimum convenience and ease of use. The system and method for sports officials training features a 3D immersion option which can be utilized with a projector for a heightened, interactive experience on a 20′×20′ screen.

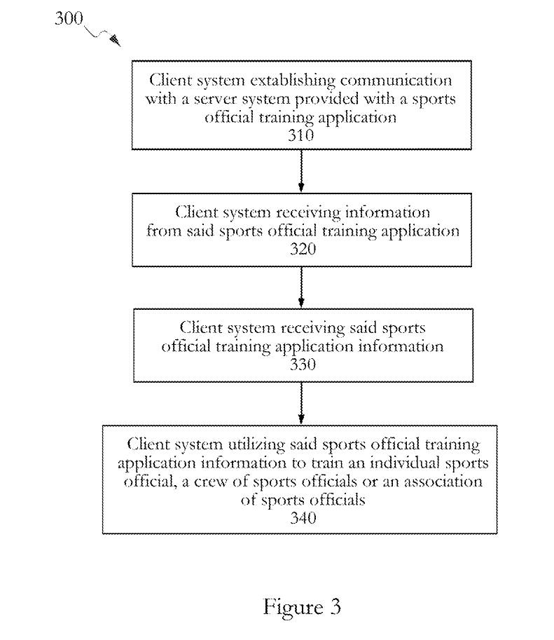

FIG. 3 illustrates a flow chart of a method 300 for sports official training, in accordance with one embodiment of the present invention. The steps of the method 300 include a client system establishing communication with a server system provided with a sports official training application 310, client system receiving sports official training application 320, client system receiving sports official training application information 330 and client system utilizing sports official training application to train an individual sports official, a crew of sports officials or an association of sports officials 340. The sports official training application information includes training categories that include a plurality of definitions, fundamentals, case plays, positioning of officials, special situations, game plays, and evaluations, as previously indicated and described in FIGS. 2A and 2B.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to train sports officials, comprising:
a server system with a processor system, a communications interface, a communications system, an input system, an output system and a input and output system having access to a communications network; and
a memory system with an operating system, a communications module, a web browser module, a web server application and a sports official training application to train sports officials.

2. The system according to claim 1, wherein said input system includes a joystick.

3. The system according to claim 1, wherein said sports official training application includes training categories that include a plurality of definitions, fundamentals, case plays, positioning of officials, special situations, game plays, and evaluations.

4. The system according to claim 3, wherein said definitions include a plurality of exact words from a rule book, an x and o depiction of said definition, a 2 dimensional picture of said definition, a 3 dimensional animation of said definition and a bird's eye view of said definition.

5. The system according to claim 3, wherein said fundamentals include an exact wording of said fundamental, a 3 dimensional animation of said fundamental and a bird's eye view of said fundamental.

6. The system according to claim 3, wherein said case plays include a narrative describing said case play, an x and o depiction of said case play, a 2 dimensional picture of said case play, a 3 dimensional animation of said case play, a bird's eye view of said case play and a rule book ruling regarding said case play.

7. The system according to claim 3, wherein said positioning of officials includes crew size positioning, sports official position positioning and game situation positioning.

8. The system according to claim 3, wherein said special situations includes crew size training, sports official position training and game situation training.

9. The system according to claim 3, wherein said game plays include applying said knowledge, said fundamentals and said positioning of officials.

10. A system to train sports officials, comprising:
a server system with a processor system, a communications interface, a communications system, an input system, an output system and a input and output system having access to a communications network; and
a memory system with an operating system, a communications module, a web browser module, a web server application and a sports official training CDROM disc to train sports officials.

11. The system according to claim 10, wherein said input system includes a joystick.

12. The system according to claim 10, wherein said sports official training application includes training categories that include a plurality of definitions, fundamentals, case plays, positioning of officials, special situations, game plays, and evaluations.

13. The system according to claim 12, wherein said definitions include a plurality of exact words from a rule book, an x and o depiction of said definition, a 2 dimensional picture of said definition, a 3 dimensional animation of said definition and a bird's eye view of said definition.

14. The system according to claim 12, wherein said fundamentals include an exact wording of said fundamental, a 3 dimensional animation of said fundamental and a bird's eye view of said fundamental.

15. The system according to claim 12, wherein said case plays include a narrative describing said case play, an x and o depiction of said case play, a 2 dimensional picture of said case play, a 3 dimensional animation of said case play, a bird's eye view of said case play and a rule book ruling regarding said case play.

16. The system according to claim 12, wherein said positioning of officials includes crew size positioning, sports official position positioning and game situation positioning.

17. The system according to claim 12, wherein said special situations includes crew size training, sports official position training and game situation training.

18. The system according to claim 12, wherein said game plays include applying said knowledge, said fundamentals and said positioning of officials.

19. A method for training sports officials, comprising:
a client system establishing communication with a server system provided with a sports official training application;
said client system receiving information from said sports official training application;
said client system receiving said sports official training application information; and
said client system utilizing said sports official training application in formation to train an individual sports official, a crew of sports officials or an association of sports officials.

20. The method according to claim 19, wherein said sports official training application includes training categories that include a plurality of definitions, fundamentals, case plays, positioning of officials, special situations, game plays, and evaluations.
